(19) United States
(12) Patent Application Publication
(10) Pub. No.: US 2009/0260506 A1
(43) Pub. Date: Oct. 22, 2009

(54) METHOD FOR CONTROLLING THE TEMPO OF A PERIODIC CONSCIOUS HUMAN PHYSIOLOGICAL ACTIVITY

(75) Inventor: Bruce M. Saperston, Hyde Park, UT (US)

Correspondence Address: Uath StateUniversity;Thorpe North Western, 570 Research Park Way, Suite 101, North Logan, UT, 84341, US

(73) Assignee: Utah State University, North Logan, UT (US)

(21) Appl. No.: 12/104,519

(22) Filed: Apr. 17, 2008

(51) Int. Cl. G10H 7/00

(52) U.S. Cl. 84/612

(57) ABSTRACT

A method for controlling the frequency of a conscious, periodic human physiological activity that comprises preparing a base track of prerecorded music having a base tempo, adding a rhythmic musical track having an activity tempo conforming with a target frequency of at least one conscious, periodic human physiological activity to the base track of prerecorded music, and configuring the base track of prerecorded music with the rhythmic musical track for playback by a human participant having interest in the target frequency.

### FIELD OF THE INVENTION

The present invention relates generally to a method for influencing human activities through music, and more specifically to a method and system for controlling conscious, periodic human physiological activities through a rhythmic musical soundtrack.

### BACKGROUND OF THE INVENTION AND RELATED ART

Music and rhythm has played an influential role in influencing human activity for millennia, as manifested by ancient battle drums, musical instruments and dance festivals. Up until the advent of record players and radio, however, any music that accompanied human activity had to be provided by live musicians. But with radio and records people could begin to organize their activities, such as work and exercise, around prerecorded music, and possibly even synchronizing their personal physical movements to music, much as they had their dance movements over the previous centuries. However, LP records and subsequent 8-track or cassette tapes usually lasted less than an hour, and radio disc jockeys often interrupted music with talk and commercials. Not until the advent of the personal, portable music player in the late 1970's could individuals effectively personalize and control their music in a manner that allowed them to influence their personal physical activities.

Since that time the personal music player industry has expanded greatly. An abundant variety of musical players and technologies have been developed in recent years, simultaneous with the growing realization that music can be highly motivational in encouraging the listener to exercise for longer periods of time or at greater intensity than he or she would without music. Consequently, there are a growing number of companies and organizations seeking the profits that can be made in the personal fitness industry by providing music systems to help the consumer to reach his or her personal fitness goals.

Recent developments in the industry have focused on music systems which provide a series of prerecorded songs played at a tempo which matches the activity of the participant, in some cases receiving a feedback signal from a sensor monitoring the activity and adjusting the tempo of the music to match the activity. However, a common drawback of these systems is that they require songs with a base tempo that is proximate the tempo of the activity, which can limit the potential selection of music and genres available to the participant. The systems also fail to take into consideration the inherent artistic nature of songs having variable tempos and loudness which can make it difficult for a participant to follow during extended periods of exercise. Another shortcoming is that these systems are geared toward personal fitness and exercise, often specifically toward the running or jogging pace of the participant, and do not have the flexibility to accommodate the many other types of human activities and processes, including physical and respiratory therapy.

### SUMMARY OF THE INVENTION

In light of the problems and deficiencies inherent in the prior art, the present invention seeks to overcome these by providing a method for controlling the frequency of a conscious, periodic human physiological activity that includes (i) preparing a base track of prerecorded music having a base tempo, (ii) adding to the base track a rhythmic musical track having an activity tempo conforming to a target frequency of the conscious, periodic human physiological activity, and (iii) configuring the base track of prerecorded music with the rhythmic musical track into a combined rhythmic audio output for playback by a participant interested in the target frequency.

The method includes various formats for the rhythmic musical track, including a separate and independent musical rhythmic component, the synthetic output of a beat generating module, or even an artificially-enhanced secondary component of the base track of prerecorded music. It also allows for adding a second rhythmic musical track to the combined rhythmic audio output having a second activity tempo conforming to the target frequency of a second conscious, human, periodic physiological activity.

The present invention further provides for controlling the target frequency, both manually or with a programmed sequence of variable training intervals. The method also includes the option of controlling the base tempo of the base track of prerecorded music to harmonically conform to the activity tempo of the rhythmic musical track.

The present invention also includes a system for controlling the frequency of a conscious, periodic human physiological activity which includes: a base track playback device for playing a base musical composition; a rhythmic track generation device for generating a rhythmic musical track; an audio mixing device for combining the base musical composition with the rhythmic musical track to form a combined rhythmic audio output; and an audio output device for playing the combined rhythmic audio output to control the frequency the activity.

### BRIEF DESCRIPTION OF THE DRAWINGS

Features and advantages of the invention will be apparent from the detailed description that follows, which taken in conjunction with the accompanying drawings, together illustrate features of the invention. It is understood that these drawings merely depict exemplary embodiments of the present invention and are not, therefore, to be considered limiting of its scope. And furthermore, it will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings, in which:

FIG. 1 is a flow chart depicting a method for controlling the frequency of a conscious, periodic human physiological activity, in accordance with an embodiment of the present invention;

FIG. 2 is a flow chart depicting a method for controlling the frequency of a conscious, periodic human physiological activity, in accordance with another embodiment of the present invention;

FIG. 3 is a flow chart depicting a method for controlling the frequency of a conscious, periodic human physiological activity, in accordance with yet another embodiment of the present invention;

FIG. 4 is a schematic block diagram and illustration of an apparatus for controlling the frequency of a conscious, periodic human physiological activity, in accordance with an embodiment of the present invention;

FIG. 5 is a schematic illustration of another apparatus for controlling the frequency of a conscious, periodic human physiological activity, in accordance with an embodiment of the present invention; and

FIG. 6 is a schematic illustration of yet another apparatus for controlling the frequency of a conscious, periodic human physiological activity, in accordance with an embodiment of the present invention.

### DETAILED DESCRIPTION OF EXEMPLARY EMBODIMENTS

The following detailed description of the invention makes reference to the accompanying drawings, which form a part thereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. As such, the following more detailed description of the exemplary embodiments is not intended to limit the scope of the present invention as it is claimed, but is presented for purposes of illustration only: to describe the features and characteristics of the present invention, and to sufficiently enable one skilled in the art to practice the invention. Accordingly, the scope of the present invention is to be defined solely by the appended claims.

In the following detailed description, the phrase “harmonically conforms” is to be understood to mean mathematically congruent in a pleasing and integrated manner in the rhythmic sense. For example, when a first rhythmic tempo has an integer relationship with a second rhythmic tempo, such as 1×, 2×, 3×, 4×, etc., the second rhythmic tempo.

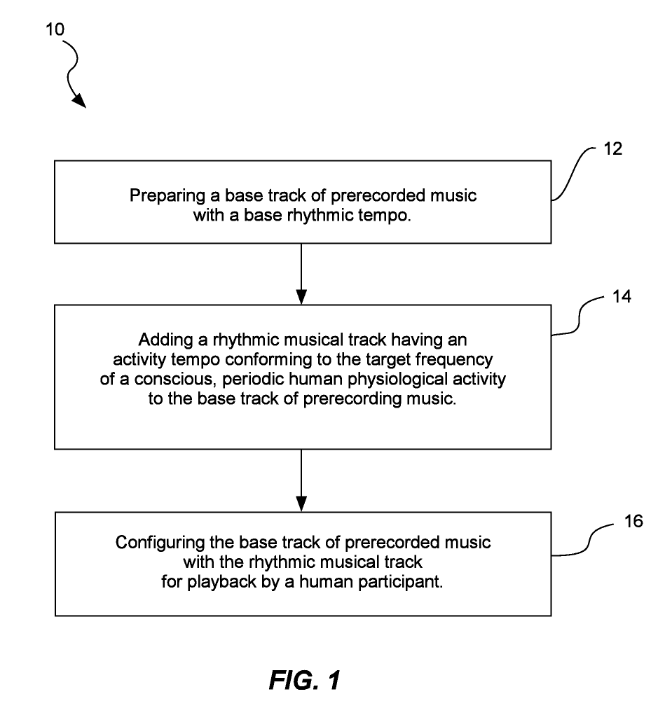

Illustrated in FIGS. 1-5 are various exemplary embodiments of the present invention for a method and system for controlling the frequency of a conscious, periodic human physiological activity. In the present invention, this activity can include any periodic physiological movement or event over which the human user has a measure of conscious control. Example activities include large body motions such as walking, running, pedaling a bicycle, etc., and other periodic physiological processes or events, such as breathing or blinking, which normally take place at the subconscious level but can still be controlled consciously if so desired.

The activity is controlled when the participant performs the periodic physiological event, movement or process in timing with the beat of a rhythmic musical track having a recognizable activity tempo corresponding to a target frequency for the activity. The rhythmic musical track is overlaid on a base track of prerecorded music that is desirable or pleasurable to the human participant, and which can have its own base tempo. The two tracks are then simultaneously played together using a combined-output player to provide the user with both a desirable musical composition and a predetermined activity tempo to which he can match his movements or other physiological processes.

The base track of prerecorded music can be any item of prerecorded music or speech or sound that is desirable or pleasurable to the human participant, and which can have its own base tempo. In many applications it is anticipated that the participant will select a group of favorite prerecorded songs to sequentially provide the base track of prerecorded music. It is possible, however, for the base track to include sounds having no recognizable base tempo, such as the sound of rain, trickling water or other random environmental noises, or spoken words such as an audio book or a talk radio show, etc.

The rhythmic musical track provides the activity tempo that corresponds to the target frequency or tempo for the activity, and can assume a variety of formats. For instance, the rhythmic musical track can be a separate and independent musical component having a strong rhythmic component, a synthetic output of a beat generating module, or even a secondary component of the base track of prerecorded music that has been artificially enhanced or amplified to bring out an activity tempo that can be different from or equal to the primary or dominant tempo of the base track.

The activity tempo and the base tempo are not required to conform to each other, and indeed, in many circumstances will not conform to each other. As stated above, it is possible for the rhythmic musical track to be overlaid on a base track of prerecorded music that has no recognizable base tempo. It is also possible for the rhythmic musical track to be combined with a base track having a base tempo that is significantly faster or slower than the activity tempo. Under those circumstances, the base track can be speed adjusted and phase synchronized with the rhythmic musical track in a way such that the base tempo harmonically conforms to the activity tempo, such as ½×, ⅓×, or ¼× the activity tempo, or 2×, 3×, or 4× the activity tempo. The base track can also be speed and phase adjusted so that the base tempo matches, or is 1×, the activity tempo.

The tempo of the rhythmic musical track can be manually controlled, or programmed to follow a predetermined sequence of variable training intervals, or a combination thereof. If manually controlled, the playback device can have control inputs which allow the participant to increase or decrease the speed of the activity tempo in defined increments to arrive at the target tempo. When used in program mode, the activity tempo of the rhythmic musical track can be programmed to follow a prescribed training sequence of variably-timed intervals, with each interval having a different target tempo. Thus, the present invention enables the participant to engage in a training regimen using an easily-identifiable beat pattern that is speed adjustable, but which still maintains the same pattern of beat sequences for the duration of the entire activity regardless of any changes to the base track of prerecorded music. This better enables the participant to stay on track without having to listen for and synchronize his movements or physiological processes with a new activity beat each time the music changes.

As will be recited here and throughout the more detailed description, the present invention provides several significant advantages over prior related art. For instance, the prior art seeks to directly influence the frequency of the periodic activity, usually exercise, through the beat of the base track of prerecorded music. This is accomplished either by selecting an item of prerecording music with a base tempo that matches the desired frequency of the conscious, periodic human physiological activity, or by slightly increasing or decreasing the playback speed of the prerecorded music selection to match that of the periodic activity. This is a significantly limiting aspect of the prior art, as there are many genres and forms of music, otherwise desirable by the participant, that have a base tempo so far removed from the target frequency of the periodic activity that it cannot be matched without extreme speed distortion.

The present invention overcomes this limitation by allowing the participant to use any item of prerecorded music as background music, with the rhythmic musical track providing the activity tempo for performing the activity superimposed on top of the prerecorded music. Regardless of the form, genre or tempo of the background prerecorded music, the existence of the rhythmic musical track in the foreground provides the appropriate motivation and sound cues for performing the activity at the proper frequency. Thus, the restriction that the base track of prerecorded music have a base tempo proximate to the desired frequency of the activity is not applicable to the present invention.

It is also recognized in the musical arts that the base tempo is often under-emphasized or not played at the beginning or end of the song, for artistic and aesthetic reasons. Musical compositions can speed up or slow down throughout the course of the song, or even stop in the middle of the piece for dramatic effect. Moreover, there can be periods of time while switching between musical compositions when there is no recognizable rhythmic tempo. These variations can create gaps in the base tempo, lasting for several seconds or more, during which the prior art ceases to provide the rhythmic sound cues which the participant seeks in performing the activity. The method and system of the present invention can provide a constant activity tempo throughout the entire course of the activity, regardless of the variations and changes taking place with the base track of prerecorded music.

The present invention also improves on the prior art by providing a rhythmic musical track that can be individually tailored and customized to the periodic activity. The participant can either create his own unique rhythmic composition, or select a rhythmic pattern that is most appropriate to the periodic movement or process from a library of beat sequences. Moreover, since it has been established that the beat sequence of the music can have a strong motivational affect on the user performing the activity, the present invention is further advantageous by providing the participant with the means to select an rhythmic musical track having a beat sequence that better matches her own preferences, while permitting a wider range of prerecorded music selections for the background base track.

Each of the above-recited advantages will be apparent in light of the detailed description set forth below, with reference to the accompanying drawings. These advantages are not meant to be limiting in any way. Indeed, one skilled in the art will appreciate that other advantages may be realized, other than those specifically recited herein, upon practicing the present invention.

The following detailed description and exemplary embodiments of the method and system for controlling the frequency of a conscious, periodic human physiological activity will be best understood by reference to the accompanying drawings, wherein the elements and features of the invention are designated by numerals throughout.

With reference to FIG. 1, illustrated is a flow chart depicting a method 10 for controlling the frequency of a conscious, periodic human physiological activity, in accordance with one embodiment of the present invention. The activity can include any periodic movement or event or physiological process over which a human user has a large measure of conscious control. For instance, large body motions such as walking, running, dancing, skipping, pedaling, hopping, jumping, dribbling, striking, swinging, throwing, kicking, swimming, picking up, putting down, twisting and the like can be included in the present invention. Recurrent physiological processes or events that normally take place at the subconscious level but can still be consciously controlled if so desired, such as breathing or blinking, also fall within the scope of the present invention. The activity is controlled when the human participant performs the periodic physiological event, movement or process in timing with the beat of a rhythmic musical track having a activity tempo, wherein the frequency of the activity tempo corresponds to the target frequency for the activity.

Other physiological processes, such as heart rate, are more difficult to consciously control except in special circumstances or with a high degree of training, and would not generally be considered to fall within the scope of the present invention.

The method 10 includes the operation 12 of preparing a base track of prerecorded music having a base tempo. The base track of prerecorded music can be any item of prerecorded music that is desirable or pleasurable to a human participant, and which has its own base tempo. It is anticipated that in many applications the participant will create the base track by downloading a group of favorite prerecorded songs into a removable storage medium such as an audio CD, mini-CD, audio cassette, DVD, or similar storage device, or organize a playlist of favorite prerecorded songs and saving it to flash memory or a magnetic hard drive in a standard MP3 or comparable digital file format. The group of songs or musical compositions forming the base track can be outputted with the appropriate base track playback device, such as a CD, mini-CD, DVD, or audio cassette player, or an MP3 or similar portable, digital music player to sequentially provide songs or musical compositions that form the base track of prerecorded music.

The base tempo provided by the base track of embodiment 10 is not used to primarily control and influence the frequency of the periodic human activity. Therefore, the prepared prerecorded music can have a base tempo that is substantially different from the frequency of the periodic human activity. This lifts the restriction commonly found in the prior art that the base track of prerecorded music have a base tempo proximate to the desired frequency of the human activity, and allows the participant to select from a wider variety of musical pieces and genres when preparing the base track.

In an alternative to the method of embodiment 10, the base track can include sounds having no recognizable base tempo or musical component, such as the sound of rain, trickling water or other random environmental noises, or even spoken words such as an audio book, etc. In another alternative to embodiment 10, the base track is not a prerecording, but instead can be a music performance, a radio talk show or a sporting event, etc. broadcast live over local or satellite radio. In the case of the last alternative, the base track playback device can be a standard or satellite radio player and the like.

Referring back to FIG. 1, the embodiment 10 of the present invention includes the operation 14 of adding a rhythmic musical track having an activity tempo to the base track of prerecorded music. The activity tempo conforms to a target frequency of the conscious, periodic human physiological activity. The rhythmic musical track can assume a variety of formats, including but not limited to: a separate and independent musical composition having a strong rhythmic component; the output of a synthetic beat generating device; or a secondary component of the base track of prerecorded music that has been artificially enhanced or amplified to bring out an activity tempo which can be equal to or different from the primary or dominant tempo of the base track.

The rhythmic musical track is produced by a rhythmic track generation device, which can comprise a speed-controllable digital music player, a synthetic beat generator, a music enhancing programmable computer processor, and the like. The rhythmic track generation device can allow for a prerecorded, independent musical composition having a strong rhythmic component to be uploaded into memory, which rhythmic composition can then be played back, often repetitiously, during combination with the base track of prerecorded music. For example, the independent musical composition could be a drum composition, the strumming of acoustic guitars, the rhythmic sound of a bass guitar, etc. The variety of prerecorded rhythmic musical compositions is virtually endless, so long as the independent musical composition can be merged with the base track of prerecorded music to form a combined output that is useful for controlling the frequency of the periodic activity.

The rhythmic track generation device can also provide the capability of producing a synthetic rhythm track having a wide variety of beat sequences and rhythmic sounds. Templates for the beat sequences and sounds can be selected from a library of sequences and sounds stored in the rhythmic track generation device or downloaded from another computational device, and synthesized for playback by the rhythmic track generation device. The rhythmic track generation device or associated software can further provide the participant with the option to compose new, unique beat sequences which better matches the movements of the periodic activity.

The capability of producing a synthetic rhythm track offers significant improvement over the prior art by providing a rhythmic musical track that can be individually tailored and customized to the periodic activity. For instance, some activities dictate that the participant perform a certain sequence of one type of event, followed by another type of event. From the library of beat sequences, the participant can select a rhythmic pattern that is most appropriate to the periodic movement or process, or create a beat pattern of his own. In illustration, one such application could be for swimmers training to take three strokes with their face in the water, and lifting their head out of the water to take a breath on the fourth stroke. In accordance with the present invention, the swimmer participant may configure the rhythmic musical track with a beat sequence that matches the sequence of strokes and breathing by generating the first three beats with one instrument and the forth beat with another.

It is further known in the art that the tempo of the music, including the beat sequence, can have a strong motivational affect on the user performing the activity. If a participant is only able to use the beat sequence included in the base track of prerecorded music, as disclosed in the prior art, the participant will often make his selection of prerecorded music based largely on a preference for a particular beat sequence. The present invention improves on the prior art by allowing the participant to select a rhythmic musical track having a beat sequence better matching his own personal preferences, while permitting a wider range of prerecorded music selections for the background base track.

The ability to generate a synthetic rhythm track is further advantageous in its flexibility and adaptability to activities beyond the scope of simple exercise. For instance, the rhythmic musical track can be adapted or customized for use in music therapy, such as in assisting a participant in learning to walk again after suffering a stroke or becoming involved in a physical accident. Individuals with such injuries often walk with a periodic but irregular gait, and the rhythmic musical track can be adapted to mimic the irregular gait while the participant becomes comfortable following rhythmic sound cues. The rhythmic sequence can then be gradually adjusted over time to train the participant to walk with a more regular pattern.

The present invention can also be adapted to other activities, including work situations in which a laborer performs physical body movements in a repeatable pattern which could be mimicked with the beat sequence of the rhythmic musical track. Playing the rhythmic musical track alongside a base track of soothing or motivating prerecorded music could be advantageous in training applications when it is desirable to instruct the employee to perform the required motions in a safe and efficient manner.

In another aspect of the present invention, the program contained in the rhythmic track generation device can identify, isolate, enhance and amplify the secondary component in the base track of prerecorded music having a tempo which can be equal to or different from the primary or dominant tempo of the base track. One useful application for this capability could be dance instruction. Social dancing is a popular pastime which places emphasis on correct body movements at particular locations in the beat pattern, such as when to step with the left foot, and when to step with the right. It is not uncommon for many beginning dancers to have difficulty identify the appropriate point in the music for making the correct movement, thus throwing off the timing for both themselves and their partner. The present invention provides an advantage over the prior art in that individual beats, corresponding with particular steps or body motions that should be performed by the participants, can be emphasized and amplified in the rhythmic musical track that is played simultaneously with the base musical composition. By providing these important audio cues to as to exactly when action should be taken, the participant dancers' enjoyment of the activity is greatly enhanced.

The speed of the activity tempo of the rhythmic musical track can be controlled manually, or programmed to follow a predetermined sequence of variable training intervals, or a combination thereof. If manually controlled, the combined-output playback device can have control inputs which allow the participant to increase or decrease the speed of the activity tempo in defined increments to arrive at the target tempo. The target tempo can also be inputted directly to the combined-output playback device in numerical format, in units such as beats/minute or beats/second.

The concept of organizing a training regimen into discrete intervals, in which the training activity is performed at a different speed or intensity during each interval, is well known in the physical fitness arts. When used in program mode, the present invention can be used to organize an interval-based training regimen in which the activity tempo is programmed to follow a prescribed training sequence of variably-timed intervals, with each interval having a different target tempo. This enables the participant to engage in a training regimen using easily-identifiable and consistent beat patterns for the duration of the entire activity, regardless of any changes to the base track of prerecorded music and variations in the speed of the activity tempo. Thus the participant can stay on track without having to listen for and synchronize his movements or processes to a new activity beat each time the music changes. The program can also allow the user to manually change the target tempo mid-interval, to either adjust all the remaining predefined tempos in the training sequence up or down, or to move out of training mode altogether and into manual control mode.

In another aspect of the present invention, the program can signal a desired increase in activity intensity by raising the loudness level of the rhythmic musical during that interval. Changes to intensity levels can also be communicated by modifying the beat sequences, rhythmic sounds or the timbre of the rhythmic musical track while maintaining the same activity tempo.

In an alternative embodiment of the present invention, the speed of the activity tempo of the rhythmic musical track can be controlled based on a relationship between the target frequency and actual frequency of the conscious, periodic human physiological activity, as measured with one or more sensing devices. For instance, if the conscious periodic activity is a body motion such as running, the movement can be measured with an accelerometer attached to the participant's body, an impact strain gauge inserted into a shoe to measure footfall impacts, or the like. If the conscious periodic activity is breathing, the inhale/exhale cycle can be monitored with a respiratory monitor. Any form of sensing device used to measure a conscious, human periodic physiological activity can be considered to fall within the scope of the present invention.

With active monitoring, the speed of the activity tempo can be adjusted based on a pre-determined mathematical relationship between the target frequency and actual frequency of the conscious periodic activity. For instance, if the actual frequency of the activity is measured as slower or faster than the target tempo, performance cues such as a series of audible tones can be added to the combined rhythmic output to direct the participant to increase or decrease her activity rate. If the participant fails to respond to the performance cues after a period of time, the activity tempo provided by the rhythmic musical track can be adjusted to match the actual frequency. In another aspect, the activity tempo can be presented at a frequency slightly faster or slower than the actual frequency of the conscious periodic activity, to influence an increase or decrease in the actual activity rate. The activity tempo can be continually adjusted faster or slower until the actual activity rate corresponds with the target frequency. In yet another aspect of active monitoring, the rhythmic musical track can be speed and phase adjusted to track and follow the beat frequency of the actual activity, to the point of providing beat sounds that precisely match the monitored motions or footfall impacts, which can have the effect of amplifying and reinforcing the actual frequency of the conscious periodic activity to the participant.

Another aspect of the present invention is to gradually control the conscious, periodic activity to a desired set point. In the field of respiratory therapy, for example, the present invention can assist in: weaning medical patient off mechanical ventilators, respirators, and the like; reducing anxiety during pediatric sedation; providing direction in respiratory therapy exercises; and assisting individuals in controlling breathing patterns in oxygen-deprived environments. The present invention can be used to provide a combined rhythmic audio output having an activity tempo corresponding to the actual respiration rate for a period of time, and then adjusting the speed of the activity tempo to influence increases or decreases in the respiration rate to an intermediate level or plateau, and after a subsequent period of time adjusting the activity tempo again until the desired set point or frequency of activity is reached. Similar benefits can be achieved in the field of physical therapy, where music-based direction can be used to encourage and support repeatable physical activity, functions and behaviors.

In another aspect of the method of the present invention, remote manual control of the target tempo can be given to individuals other than the participant, such as a coach, personal trainer, or physical or respiratory therapist.

In the above-cited examples, the present invention is particularly advantageous over the prior art as the frequency of the conscious, periodic activity can be significantly different than the base tempo of the prerecorded music used to calm or motivate the participant. By providing a rhythmic musical track that is separate than the base track of prerecorded music, the base track can be of a more continuous nature while the activity tempo of the rhythmic musical track is free to be adjusted to control the pace of the activity as desired.

The embodiment 10 of the present invention depicted in FIG. 1 includes the operation 16 of configuring the base track of prerecorded music with the rhythmic musical track for playback by a human participant. The audio outputs from the base track playback device and the rhythmic track generation device are combined by a audio mixing device to produce a combined rhythmic audio output. The audio mixing device can be configured to receive both analog and digital inputs, thus allowing the output signals from the base track playback device and the rhythmic track generation device to be analog or digital. Upon receiving the two inputs, the audio mixing device can: condition the signals, such as converting the signals from analog to digital or vice versa, setting the relative volume level between the two audio signals, synchronizing speed and/or phase of the base tempo with the activity tempo if needed, etc.; mix the two inputs into one combined rhythmic audio output; and send the combined rhythmic audio output to an output device, such as loudspeakers, headset, and a pair of earphones or ear buds.

As stated above, the activity tempo and the base tempo of the combined output are not required to conform to each other, and indeed, in many circumstances will not conform to each other. It is possible, for instance, for the rhythmic musical track to be overlaid on a base track of prerecorded music that has no recognizable base tempo. It is also possible for the rhythmic musical track to be combined with a base track having a base tempo that is significantly faster or slower than the activity tempo. An example scenario could be the activity of pedaling a bicycle at high RPM's in timing with a fast tempo rhythmic musical track, while simultaneously enjoying a prerecorded track of classical music having much slower base tempo.

It is also possible to use the audio mixing device to combine the activity tempo and the base tempo in a way such that the base tempo harmonically conforms to the activity tempo. In the peddling-to-classical-music example described above, the base tempo could speed and phase adjusted to be 1½×, ⅓×, or ¼ the activity tempo, so that every few seconds the beats of the two tempos coincide in a pleasing manner. Using a similar approach, the base tempo could speed and phase adjusted to be 2×, 3×, or 4× the activity tempo, as could be the case when walking to a base track from the high-energy rock, heavy metal or techno genres. The base track can also be speed and phase adjusted so that the base tempo matches, or is 1×, the activity tempo.

When modifying the tempo of the base track of pre-recorded music, the base track playback device can be speed adjustable, and either the audio mixing device or rhythmic track generation device can provide a feedback signal to the base track playback device for controlling its speed.

In another embodiment of the present invention, the rhythmic track generation device can be configured to provide a second rhythmic musical track having a second activity tempo, wherein the second activity tempo coincides with a target frequency of a second conscious, human periodic physiological activity. For instance, it can be beneficial to the training of professional athletes to control both the pace of the movement, such as pedaling a bicycle, and the respiration rate of the participant. As the frequencies of the movement and the process may not coincide, two activity tracks with distinct rhythmic sounds can be presented to the participant, while at the same time providing a motivational background base track of prerecorded music.

The rhythmic track generation device can generate the separate rhythmic musical tracks and combine them internally before outputting a merged activity tempo track to the audio mixing device, or it can provide the first and second rhythmic musical tracks separately to be combined with the base track later in the audio mixing device.

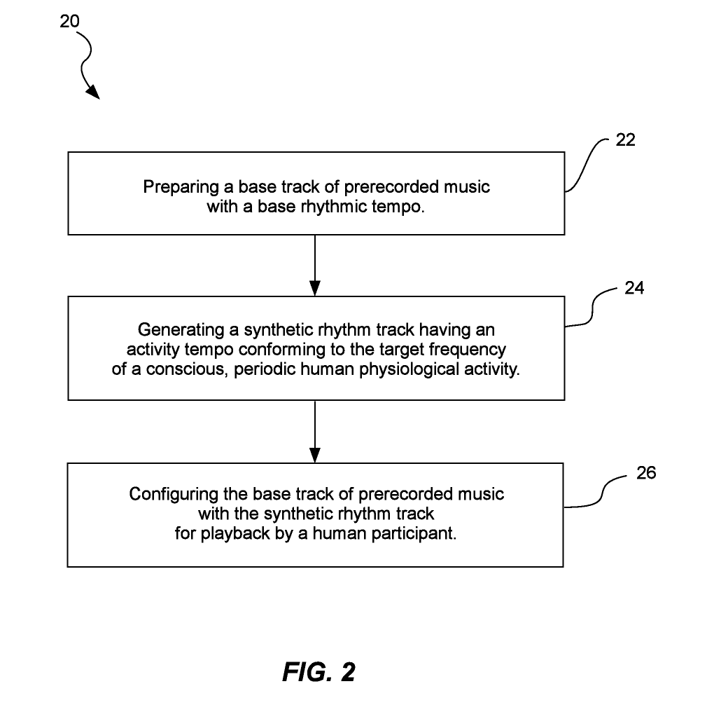

Illustrated in the flowchart of FIG. 2 is an embodiment 20 of the method of the present invention which includes the operation 22 of preparing a prerecorded music track having a base tempo for output by a base track playback device. The method further includes the operation 24 of generating at least one synthetic rhythm track, with a rhythmic track generation device, that has an activity tempo conforming with a target frequency of at least one conscious, periodic human physiological activity. The method further comprises the operation 26 of configuring the prerecorded music track with the synthetic rhythm track, using a audio mixing device, for playback by a human participant having interest in the target frequency.

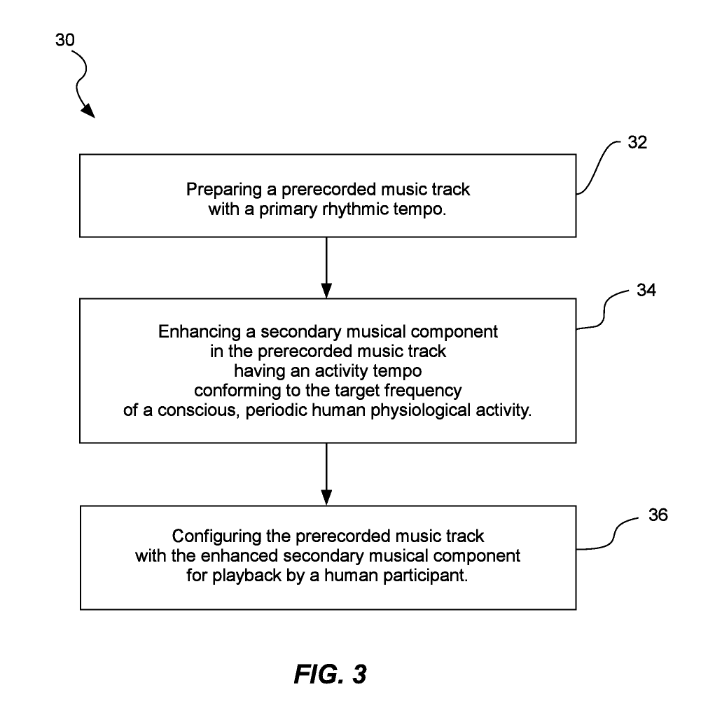

FIG. 3 is a flowchart depicting another embodiment 30 of the method of the present invention which includes preparing 32 a prerecorded music track having a base tempo for output by a base track playback device. The method further includes enhancing 34 a secondary musical component of the base track having a secondary, activity tempo different from the primary or dominant tempo of the base track, but at the same time conforming with a target frequency of at least one conscious, periodic human physiological activity. A rhythmic track generation device can identify, isolate, enhance and amplify the secondary component in the base track to provide an enhanced secondary rhythm track, which is then configured 36 with the prerecorded music track in an audio mixing device for playback by a human participant interested in the target frequency.

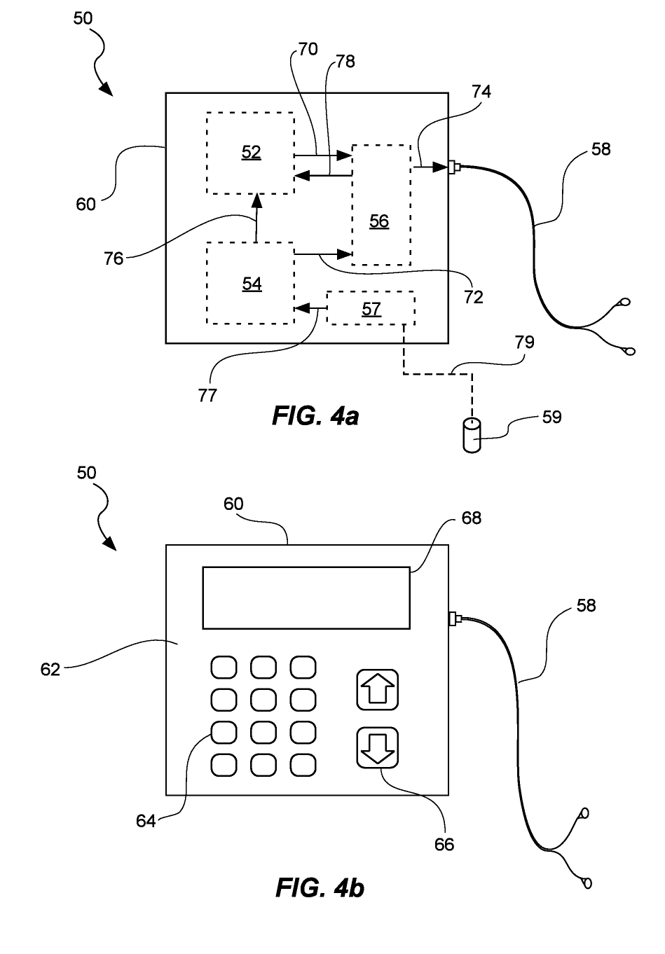

Shown in FIG. 4a is a schematic block diagram of an apparatus 50 for controlling the frequency of a conscious, periodic human physiological activity, in accordance with an embodiment of the present invention. The apparatus 50 can include a number of functional modules, including a base track playback device 52, a rhythmic track generation device 54, and an audio mixing device 56. As discussed hereinabove, the base track playback device 52 can be a CD, mini-CD, DVD, or audio cassette player, or an MP3 or similar portable, digital music player, or a standard or satellite radio player and the like that is capable of providing a base track that is desirable or pleasurable to the human participant, and which may or may not have its own base tempo.

The rhythmic track generation device 54 provides a rhythmic musical track having an activity tempo conforming to the target frequency of the conscious, periodic human physiological activity, and can include a speed-controllable digital music player, a synthetic beat generator, a music enhancing programmable computer processor, and the like. The rhythmic musical track can be generated in a variety of formats, including a separate and independent musical composition having a strong rhythmic component; the output of a synthetic beat generating device; or a secondary component of the base track of prerecorded music that has been artificially enhanced. Furthermore, the rhythmic track generation device can alter the tempo of the rhythmic musical track, through manual control, a programmed sequence of variable training intervals, etc..

The audio signal 70 from the base track playback device 52 and the audio signal 72 from the rhythmic track generation device 54 are merged in the audio mixing device 56 to produce a combined rhythmic audio output 74. The audio mixing device can combine and condition the audio signals, including converting the signals from analog to digital or vice versa, setting the relative volume level between the two audio signals, synchronizing speed and/or phase of the base tempo with the activity tempo if needed, and mixing the two inputs into one output. The audio mixing device sends the combined rhythmic audio output to an output device 58, such as loudspeakers, a headset, or a pair of earphones or ear buds.

The base track playback device 52, the rhythmic track generation device 54, and the audio mixing device 56 can all be separate and independent devices, each having a programmable computer processor, memory, firmware, and the capability for software to be uploaded into the device. As illustrated in FIGS. 4a and 4b, all three devices can also be integrated as functional modules into a combined-output player 60 providing a combined rhythmic audio output to an output device 58. The combined-output player can include a programmable computer processor, memory, firmware, and programmable software which are all shared by the three modules, as well as a common player interface 62 having control inputs 64 and 66, and a display screen 68. The combined-output player can further include the capability for wired and wireless connectivity with a programmable computer for remote operation via a software interface.

The apparatus 50 can also include a monitoring module 57 for monitoring one or more sensing devices 59 or sensors used to measure the actual frequency of the conscious, periodic human physiological activity. The monitoring module can connect to and interface with the several types of sensing devices capable of measuring an activity. If the conscious periodic activity is a body motion such as running, for instance, the movement can be measured with an accelerometer attached to the participant's body, an impact strain gauge inserted into a shoe to measure footfall impacts, or the like. If the conscious periodic activity is breathing, the inhale/exhale cycle can be monitored with a respiratory monitor. The sensor monitoring module can be configured to connect with the sensing device via an interface connection 79, such as a direct, wired connection, wireless technology, or even with a sensor installed within the monitoring module 57 or apparatus 50 itself, such as an accelerometer.

When used in active monitoring mode, the sensor monitoring module 57 can provide a tempo signal 77 proportional to the actual frequency of the conscious periodic activity to the rhythmic track generation device 54, which can then adjust the speed of the activity tempo provided to the audio mixing device 56 or the base track playback device 52. The speed of the activity tempo can be based on a pre-determined mathematical relationship between the target frequency and actual frequency of the conscious periodic activity, as discussed hereinabove.

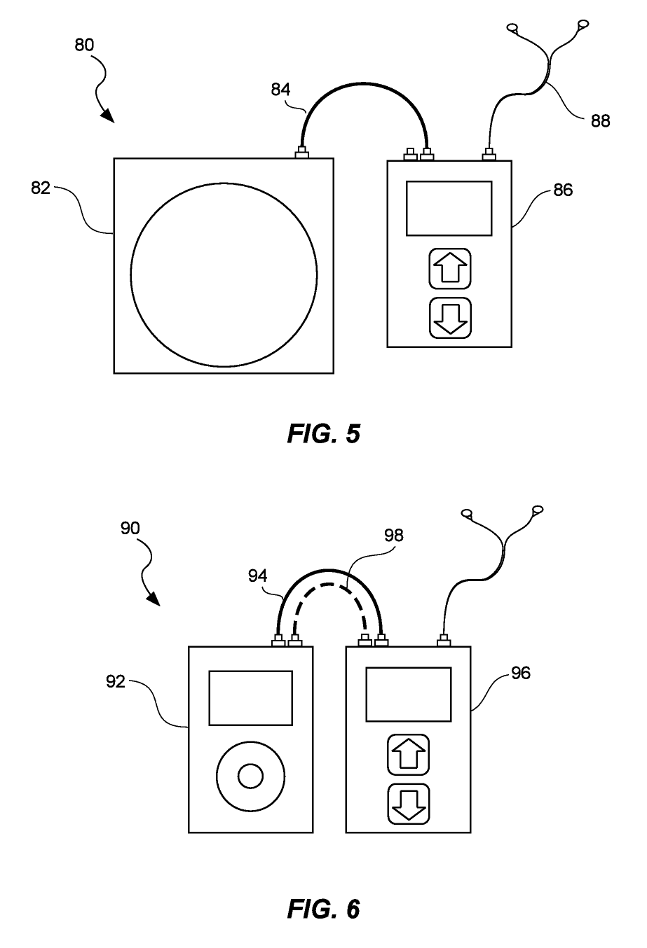

Illustrated in FIG. 5 is another embodiment 80 of the present invention, in which the base track playback device is an external, freestanding music player 82, such as a common portable CD player. The music player provides a base track of recorded music 84 to a combined-output player 86, which can include a rhythmic track generation module and an audio mixing module. The combined-output player receives the base track audio signal from the music player, generates its own rhythmic musical track, mixes the two audio signals into one audio output, and sends the signal to an output device 88. As the external, freestanding music player is provided with a separate control system and plays the CD at a constant speed, there is no feedback or synchronization between the base track of prerecorded music provided by the music player and the rhythmic musical track provided by the combined-output player 86. This embodiment of the present invention is advantageous as it can be used with existing base track playback devices.

In another embodiment 90 of the present invention illustrated in FIG. 6, the base track playback device is an external, freestanding music player 92 having a control system which can be coupled with the combined-output player 96. In this configuration, the combined-output player can provide a feedback signal 98 to the music player controlling the music playback speed, so that the base tempo of the prerecorded music 94 harmonically conforms to the activity tempo of the rhythmic musical track generated in the combined-output player 96. Upon receiving the base track audio input, the rhythmic track generation module and/or the audio mixing module within the combined-output player can synchronize the phase of the base tempo with the activity tempo, so that the beats of the two signals align together in the combined rhythmic audio output.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A method for controlling the frequency of a conscious, periodic human physiological activity, comprising:
preparing a base track of prerecorded music having a base tempo;
adding at least one rhythmic musical track having an activity tempo to the base track of prerecorded music, wherein the activity tempo conforms with a target frequency of at least one conscious, periodic human physiological activity; and
configuring the base track of prerecorded music with the at least one rhythmic musical track for playback by a human participant having interest in the target frequency.

2. The method of claim 1, wherein the at least one rhythmic musical track is selected from the group consisting of a separate and independent musical rhythmic component, a synthetic output of a beat generating module, and an artificially-enhanced secondary component of the base track of prerecorded music.

3. The method of claim 1, further comprising controlling the base tempo of the base track of prerecorded music to harmonically conform to the activity tempo of the at least one rhythmic musical track.

4. The method of claim 1, wherein the target frequency is manually controlled.

5. The method of claim 1, wherein the target frequency follows a predetermined sequence of variable training intervals.

6. The method of claim 1, further comprising monitoring an actual frequency of the at least one conscious, periodic human physiological activity with a sensing device, and conforming the activity tempo to a pre-determined mathematical relationship between the target frequency and actual frequency.

7. The method of claim 1, wherein the at least one conscious periodic physiological activity is selected from the group consisting of body motions and respiration.

8. The method of claim 1, further comprising adding a second rhythmic musical track having a second activity tempo, wherein the second activity tempo conforms with a target frequency of a second conscious, human periodic physiological activity.

9. A method for controlling the frequency of a conscious, human periodic physiological activity comprising:
preparing a prerecorded music track having a base tempo;
adding at least one synthetic rhythm track having an activity tempo to the prerecorded music track, wherein the activity tempo conforms with a target frequency of at least one conscious, periodic human physiological activity; and
configuring the prerecorded music track with the synthetic rhythm track for playback by a human participant having interest in the target frequency.

10. The method of claim 9, further comprising controlling the base tempo of the prerecorded music track to harmonically conform to the activity tempo.

11. The method of claim 9, wherein the target frequency is manually controlled.

12. The method of claim 9, wherein the target frequency follows a predetermined sequence of variable training intervals.

13. The method of claim 9, further comprising monitoring an actual frequency of the at least one conscious, periodic human physiological activity with a sensing device, and conforming the activity tempo to a pre-determined mathematical relationship between the target frequency and actual frequency.

14. The method of claim 9, wherein the at least one conscious periodic physiological activity is selected from the group consisting of body motions and respiration.

15. The method of claim 9, further comprising adding a second synthetic rhythm track having a second activity tempo, wherein the second activity tempo conforms with a target frequency of a second conscious, human periodic physiological activity.

16. A method for influencing the frequency of a conscious, periodic human physiological activity comprising:
preparing a prerecorded music track having a base tempo;
enhancing a secondary musical component of the item of prerecorded music having an activity tempo, wherein the activity tempo conforms with a target frequency of at least one conscious, periodic human physiological activity; and
configuring the prerecorded music track with the enhanced secondary musical component for playback by a human participant having interest in the target frequency.

17. The method of claim 16, wherein the at least one conscious periodic physiological activity is selected from the group consisting of body motions and respiration.

18. A system for controlling the frequency of a conscious, periodic human physiological activity comprising:
a base track playback device for playing a base track of prerecorded music;
a rhythmic track generation device for generating at least rhythmic musical track, wherein the rhythmic track generation device is programmable for generating the at least one rhythmic musical track at a predetermined target tempo;
an audio mixing device for combining the base track of prerecorded music with the at least one rhythmic musical track to form a combined rhythmic audio output; and
an audio output device electronically coupled to the audio mixing device for playing the combined rhythmic audio output to control the frequency of at least one conscious periodic physiological activity.

19. The system of claim 18, wherein the at least one rhythmic musical track is selected from the group consisting of a separate and independent musical rhythmic component, a synthetic output of a beat generating module, and an artificially-enhanced secondary component of the base track of prerecorded music.

20. The system of claim 18, wherein the base track playback device is selected from the group consisting of digital music playback devices, MP3 players, CD players, cassette players, LP record players, radio players, satellite radio players, DVD players and video cassette players.

21. The system of claim 18, wherein the base track playback device is speed adjustable to play the base track of prerecorded music at a tempo that harmonically conforms with the at least one rhythmic musical track.

22. The system of claim 18, wherein the predetermined target tempo is manually controlled.

23. The system of claim 18, wherein the predetermined target tempo follows a programmed sequence of variable training intervals.

24. The system of claim 18, wherein the at least one conscious, periodic human physiological activity is selected from the group consisting of body motions and respiration.

25. The system of claim 18, wherein the rhythmic track generation device is programmable for generating a second rhythmic musical track at a second rhythmic tempo, and wherein the second rhythmic tempo conforms with a target frequency of a second conscious, human periodic physiological activity.
